(19) United States
(12) Patent Application Publication
(10) Pub. No.: US 2020/0386250 A1
(43) Pub. Date: Dec. 10, 2020

(54) METHOD AND SYSTEM FOR SECURING MINI-FRIDGE

(71) Applicant: BERMANFALK HOSPITALITY GROUP LLP, Langley (CA)

(72) Inventor: Gary BERMAN, Langley (CA)

(21) Appl. No.: 16/962,198

(22) PCT Filed: Apr. 23, 2019
(86) PCT No.: PCT/CA2019/050512

§ 371 Date: Jul. 14, 2020

Related U.S. Application Data
(60) Provisional application No. 62/662,094, filed on Apr. 24, 2018.

(51) Int. Cl. F16B 2/04; F25D 23/10

(52) U.S. Cl. CPC F16B 2/04; F25D 23/10

(57) ABSTRACT

A method and system are provided for securing non-fixed structures against movement relative to fixed structures, and in particular to a method and system for securing mini-fridges within cabinets. The method and system employ a stabilizer comprising a pair of foot assemblies, wherein at least one of the foot assemblies is extendable in relation to the other one of the foot assemblies, each of the foot assemblies comprising a foot. The stabilizer is positionable in a gap defined by an exterior surface of the mini-fridge and an interior surface of the cabinet. The stabilizer is extended until one foot is in contact with the exterior surface of the mini-fridge and the other foot is in contact with the interior surface of the cabinet, such that the stabilizer is snugly fit in the gap to prevent relative movement between the mini-fridge and the cabinet.

### REFERENCE TO RELATED APPLICATIONS

This application claims priority to and the benefit of U.S. provisional patent application No. 62/662,094 filed 24 Apr. 2018 which is hereby incorporated by reference in its entirety.

### FIELD

This invention relates to methods and systems for securing non-fixed structures against movement relative to fixed structures, and in particular to a method and system for securing mini-fridges within cabinets.

### BACKGROUND

Many hotels, motels, resorts, and other establishments provide miniature refrigerators, or mini-fridges, in the rooms of their guests. Oftentimes, these mini-fridges are stored within a cabinet or cupboard, so as to remain inconspicuous or to not diminish the décor of the room. The gap between an exterior surface of the mini-fridge and an interior surface (e.g. interior ceiling or interior wall) of the cabinet may range anywhere for example from 20 mm to 300 mm.

The problem with storing such mini-fridges inside cabinets is that the mini-fridge may tend to shift or slide back and forth within the cabinet when the door of the mini-fridge is opened or closed. This is inconvenient, and may damage the cabinet and/or the mini-fridge, set off sensors or alarms on the mini-fridge, and/or the like.

There remains a need for a method and system for securing a mini-fridge against movement within a cabinet during usage of the mini-fridge.

### SUMMARY

One aspect of the invention relates to a method for stabilizing a mini-fridge against movement relative to a cabinet. The method comprises positioning a mini-fridge in a desired location in a cabinet; providing a stabilizer, the stabilizer comprising a pair of foot assemblies, wherein at least one of the foot assemblies is extendable in a longitudinal direction in relation to the other one of the foot assemblies, each of the foot assemblies comprising a foot; positioning the stabilizer into a gap defined by an exterior surface of the mini-fridge and an interior surface of the cabinet such that the longitudinal direction extends generally perpendicularly to the exterior surface of the mini-fridge and the interior surface of the cabinet; and extending at least one of the feet of the stabilizer until one foot is in contact with the exterior surface of the mini-fridge and the other foot is in contact with the exterior surface of the cabinet, such that the stabilizer is snugly fit in the gap to prevent relative movement between the mini-fridge and the cabinet.

One aspect of the invention relates to a system for securing a mini-fridge in a cabinet, the cabinet comprising an interior space sufficient to house the mini-fridge. The system comprises a stabilizer comprising a pair of foot assemblies, wherein at least one of the foot assemblies is extendable in a longitudinal direction in relation to the other one of the foot assemblies, each of the foot assemblies comprising a foot. The stabilizer is positionable in a gap defined by an exterior surface of the mini-fridge and the interior surface of the cabinet such that the longitudinal direction extends generally perpendicularly to the exterior surface of the mini-fridge and the interior surface of the cabinet. At least one of the feet is extendable until it is in contact with the exterior surface of the mini-fridge and the other foot is in contact with the exterior surface of the cabinet, such that the stabilizer is snugly fit in the gap to prevent relative movement between the mini-fridge and the cabinet.

In some embodiments the friction force between the feet of the stabilizer and the exterior surface of the mini-fridge and the interior surface of the cabinet is great enough to overcome a force provided by opening or closing a door of the mini-fridge. In some embodiments the exterior surface of the mini-fridge is an upper exterior surface of the mini-fridge and the interior surface of the cabinet is an upper interior surface of the cabinet. In other embodiments the exterior surface of the mini-fridge is a side exterior surface of the mini-fridge and the interior surface of the cabinet is a side interior surface of the cabinet.

In some embodiments the stabilizer may comprise a bar that engages the foot assemblies at opposing ends thereof. The bar may comprise at least one axial bore for threaded engagement with a threaded arm of at least one of the foot assemblies. In some embodiments one of the foot assemblies comprises a threaded bore and the other one of the foot assemblies comprises a threaded arm for threadingly engaging the threaded bore. In some embodiments the gap between the exterior surface of the mini-fridge and the interior surface of the cabinet is between 20 mm to 300 mm.

In some embodiments the feet comprise bearing surfaces made of high friction material and/or featuring high friction features. In some embodiments the feet may comprise truncated cones of rubber.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a block diagram of a method for securing a non-fixed structure against movement relative to a fixed structure, according to one embodiment of the invention.

FIG. 2 is a schematic diagram of a stabilizer used in the method shown in FIG. 1, according to one embodiment of the invention.

FIG. 2A shows the stabilizer shown in FIG. 2 in an extended position.

FIG. 3 is a schematic view of the stabilizer shown in FIG. 2 installed between a non-fixed structure and a fixed structure, according to one embodiment of the invention.

FIG. 4A is a schematic view of the stabilizer shown in FIG. 2 installed between a mini-fridge and a cabinet, according to one embodiment of the invention.

FIG. 4B is a schematic view of two stabilizers as shown in FIG. 2 installed between a mini-fridge and a cabinet, according to one embodiment of the invention.

FIGS. 5A to 5C are schematic, partial cut through, views of a stabilizer according to one embodiment of the invention.

FIGS. 6A to 6C are schematic, partial cut through, views of a stabilizer according to one embodiment of the invention.

FIGS. 7A to 7C are schematic, partial cut through, views of a stabilizer according to one embodiment of the invention.

### DETAILED DESCRIPTION

Throughout the following description, specific details are set forth in order to provide a more thorough understanding of the invention. However, the invention may be practiced without these particulars. In other instances, well-known elements have not been shown or described in detail to avoid unnecessary obscuring of the invention. Accordingly, the specification and drawings are to be regarded in an illustrative, rather than a restrictive, sense.

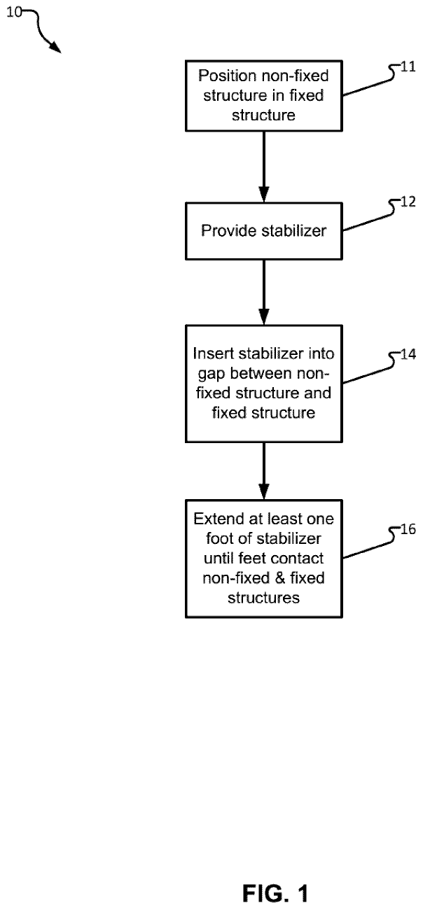

One aspect of this invention provides a method 10 for stabilizing a non-fixed structure against movement relative to a fixed structure. A block diagram of method 10, according to one embodiment of the invention, is shown in FIG. 1.

Method 10 comprises, in block 11, positioning a non-fixed structure in a fixed structure at a desirable location. In block 12 a stabilizer is provided. The stabilizer may comprise a bar with feet on opposing ends of the bar, wherein at least one of the feet is extendable in a longitudinal direction which extends along the length of the bar.

In block 14, the stabilizer is inserted into a gap between a surface of the non-fixed structure and a surface of the fixed structure such that the longitudinal direction defined by the bar extends generally perpendicularly to the surfaces of the non-fixed structure and the fixed structure which define the gap. In some embodiments, the longitudinal direction may extend generally vertically.

In block 16, at least one of the feet of the stabilizer is then extended until one foot is in contact with the non-fixed structure and one foot is in contact with the fixed structure. In such a configuration, the stabilizer may be snugly fit in the gap between the non-fixed structure and the fixed structure, such that relative movement (e.g. sliding movement) between the non-fixed structure and the fixed structure is prevented. That is, a “snug fit” may mean that the friction force between the feet of the stabilizer and the surfaces of the non-fixed and fixed structures may be great enough to overcome a force which would tend to shift or move the non-fixed structure relative to the fixed structure (e.g. where the non-fixed structure is a mini-fridge, the force provided by opening or closing the door of the mini-fridge).

In some embodiments, the non-fixed structure is a mini-fridge and the fixed structure is a cabinet. Installing the stabilizer between the mini-fridge and the cabinet (e.g. between a top surface of the mini-fridge and the ceiling of the cabinet) may prevent the mini-fridge from sliding within the cabinet when the door of the mini-fridge is opened or closed.

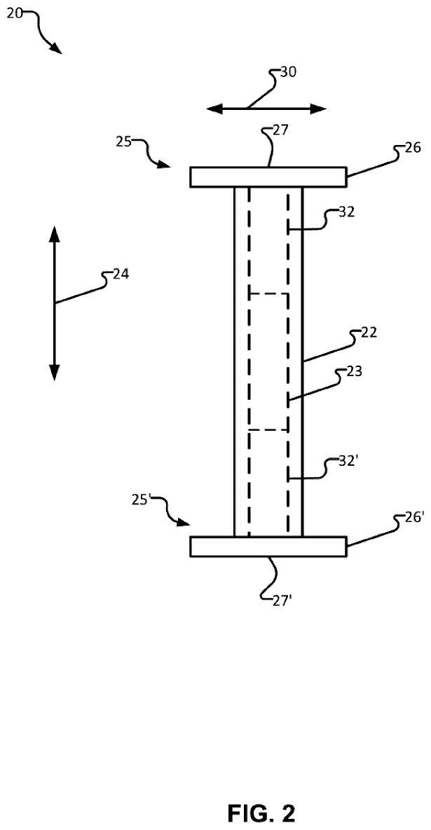

FIG. 2 shows a stabilizer 20 which may be provided in step 12 of method 10, according to an example embodiment of the invention. Stabilizer 20 comprises a bar 22 which defines a longitudinal direction 24 normal to transverse direction 30. A pair of foot assemblies 25, 25′ is located at opposing ends of bar 22. Each foot assembly 25, 25′ includes a foot 26, 26′ and an arm 32, 32′ projecting from a respective foot 26, 26′. Each foot 26, 26′ has a bearing surface 27, 27′ defining a transverse direction 30.

Bearing surfaces 27, 27′ contact the non-moving surface and moving surface. In some embodiments bearing surfaces 27, 27′ are high friction surfaces. In particular embodiments bearing surfaces 27, 27′ may be made of high friction material (e.g. rubber and the like) and/or have high friction surface features (e.g. ridges and the like).

Feet 26, 26′ may be any suitable shape, such as discs, polygonal blocks, or truncated cones. Truncated cones are advantageous since they provide sufficient area of bearing surface area, sufficient volume for sturdy attachment to the threaded arms, all while using less material.

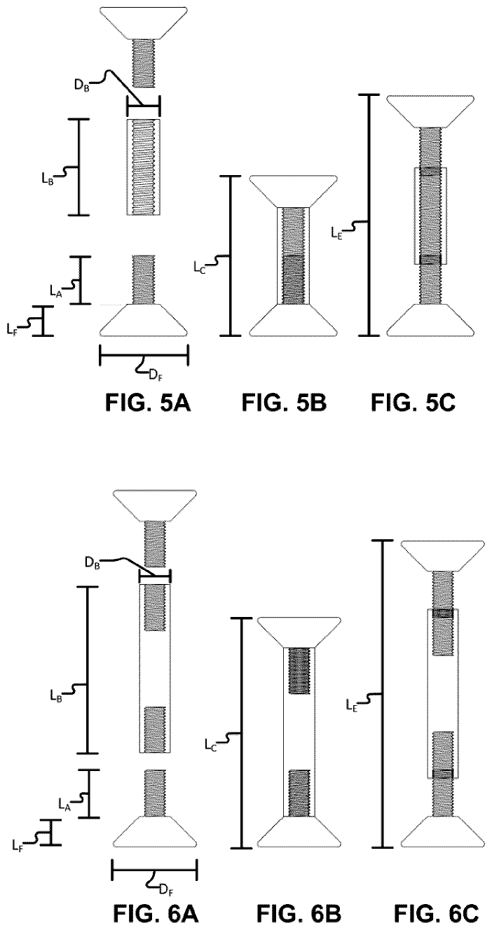

One or both foot assemblies 25, 25′ may be extendable in longitudinal direction 24 away from bar 22. FIG. 2 shows stabilizer 20 in its most “compressed” position, i.e. with feet 26, 26′ in their closest possible position to bar 22, according to one example embodiment. In some embodiments, one or both of foot assemblies 25, 25′ are threaded into a threaded bore 23 of bar 22 by threaded arms 32, 32′. In some embodiments a single threaded bore 23 extends through the entire length of bar 22. In other embodiments, bar 22 includes two threaded bores 23, one at each end of bar 22 (as shown for example in FIGS. 6A to 6C). In yet other embodiments (not shown), arms 32, 32′ may have threaded bores into which threaded ends of bar 22 may threadingly insert.

FIG. 2A shows an example embodiment where both of foot assemblies 25, 25′ are threaded into bar 22. FIG. 2A shows stabilizer 20 in an “extended” position, where feet 26, 26′ are relatively farther away from bar 22 as compared with the compressed position shown in FIG. 2. As shown in FIG. 2A, foot assemblies 25, 25′ need not extend the same distance in longitudinal direction 24 away from bar 22. That is, the distance between foot 26 and bar 22 may or may not be the same as the distance between foot 26′ and bar 22.

In another example embodiment (not shown), feet 26, 26′ are biased away from bar 22 in longitudinal direction 24 (for example, by one or more springs or other biasing members within bar 22). In such embodiments, stabilizer 20 may naturally be in its fully-extended position. Stabilizer 20 may then be manually compressed in order for it to be installed between the non-fixed structure and the fixed structure. The biasing member(s) may then extend one or both of foot assemblies 25, 25′ such that stabilizer 20 is snugly fit in the gap between the non-fixed structure and the fixed structure to prevent relative movement between these structures.

Foot assemblies 25, 25′ may be mounted to bar 22 on threaded arms 32, 32′ on swivel heads (not shown). This may allow feet 26, 26′ to pivot relative to bar 22 or threaded arms 32, 32′ (i.e. such that transverse direction 30 defined by bearing surfaces 27, 27′ of feet 26, 26′ is not exactly perpendicular to longitudinal direction 24 defined by bar 22). This allows stabilizer 20 to prevent relative movement between a non-fixed structure (such as a mini-fridge) and a fixed structure (such as a cabinet) even when the surfaces of these structures which contact bearing surfaces 27, 27 of feet 26, 26′ are not exactly parallel (e.g. when the non-fixed structure is tilted slightly relative to the fixed structure).

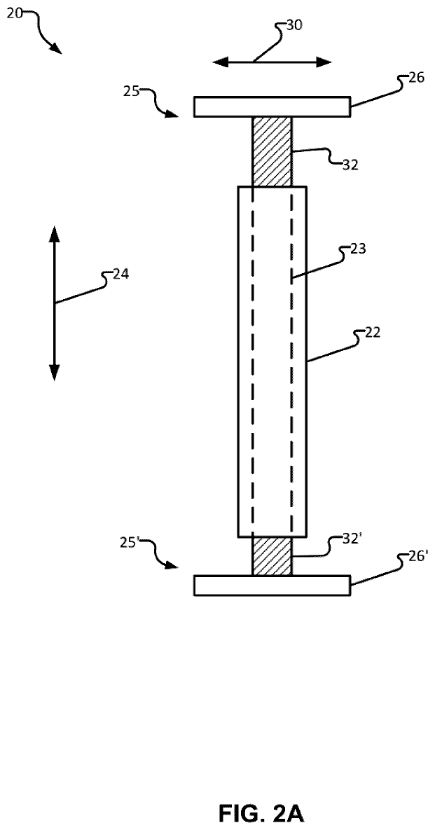

FIG. 3 shows stabilizer 20 inserted into a gap 34 between a surface of a non-fixed structure 36 and a surface of a fixed structure 38 (i.e. FIG. 3 depicts steps 14 and 16 of method 10). The size of gap 34 relative to non-fixed structure 36, fixed structure 38, and stabilizer 20 may not be to scale in FIG. 3. As described above, gap 34 may be between 20 mm and 300 mm.

As shown in FIG. 3, both foot assemblies 25, 25′ of stabilizer 20 may be extended away from bar 22 in longitudinal direction 24 until they bear against surfaces of fixed structure 38 and non-fixed structure 36, respectively. Foot assemblies 25, 25′ may be extended in longitudinal direction 24 (e.g. by manually unthreading threaded arms 32, 32′ out of body 22) until stabilizer 20 is snugly fit within gap 34 between non-fixed structure 36 and fixed structure 38. In other words, stabilizer 20 provides a normal force to non-fixed structure 36 (e.g. in a direction parallel to longitudinal direction 24) which is such that the friction force acting on non-fixed structure 36 is sufficient to overcome a force which would otherwise tend to shift or move non-fixed structure 36 relative to fixed structure 38 (e.g. in a plane parallel to transverse direction 24).

In this way, stabilizer 20 prevents relative movement in any direction between non-fixed structure 36 and fixed structure 38 (for example, movement of non-fixed structure 36 in the direction extending into and out of the page in FIG. 3). For example, stabilizer 20 may prevent sliding movement of a mini-fridge which may otherwise occur during the opening and closing of the door of the mini-fridge.

Once stabilizer 20 is installed between non-fixed structure 36 and fixed structure 38 as shown in FIG. 3, it may remain in that position indefinitely. To remove stabilizer 20, stabilizer 20 is compressed (e.g. one or both of threaded arms 32, 32′ are threaded into body 22) until one or both of feet 26, 26′ are no longer in contact with one or both of structures 36, 38 and stabilizer 20 is able to be removed from gap 34.

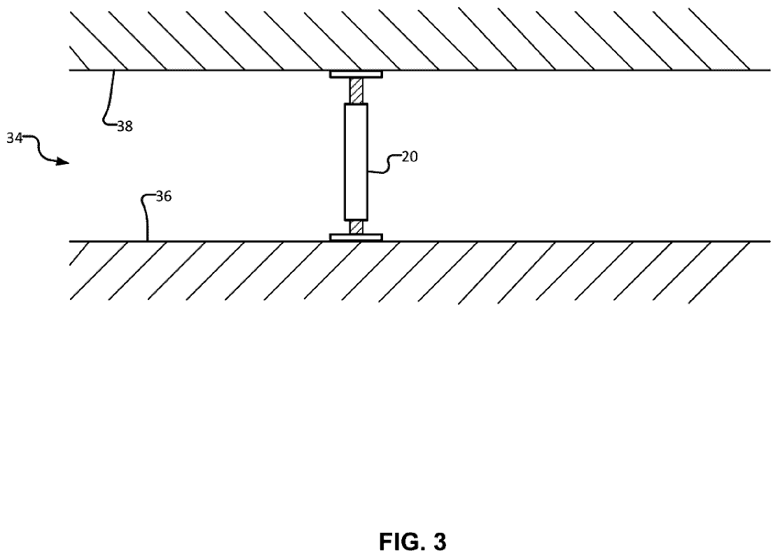

In some embodiments, non-fixed structure 36 is a mini-fridge, and fixed structure 38 is a cabinet, and the stabilizer spans a gap defined by an upper surface of the mini-fridge and an interior upper surface of the cabinet. In such embodiments, only one stabilizer 20 may be needed to prevent relative movement between a mini-fridge MF and a cabinet C as shown in FIG. 4A. In other embodiments, two or more stabilizers 20 may be used in gap 34.

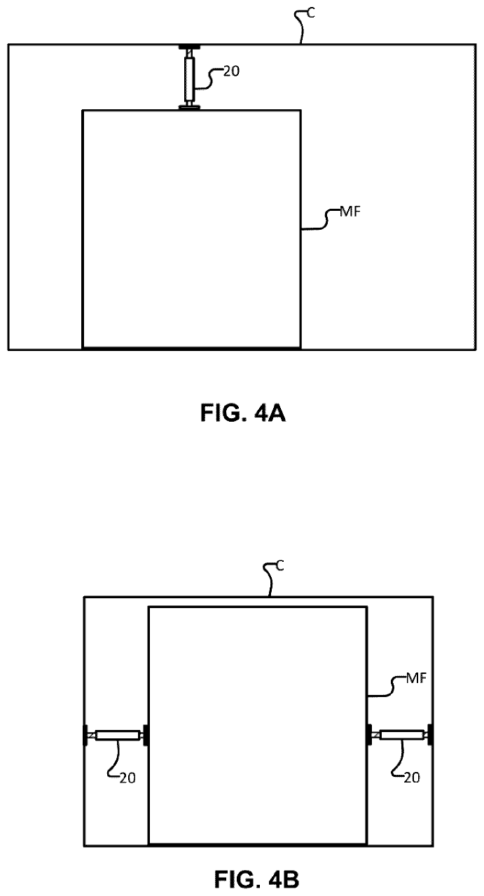

In some embodiments, when stabilizer 20 is in the compressed position (as shown in FIGS. 2, 5B and 6B), its length L_{C} may for example range from 38.0 mm to 250.0 mm. When stabilizer 20 is in its fully-extended position (as shown in FIGS. 5C and 6C), its length L_{E} may for example range from 54.0 mm to 300.0 mm. The size of stabilizer 20 deployed depends on the size of gap 34, the mini-fridge, and the cabinet. In some embodiments, and having regard to FIGS. 5A to 6C, the length of the bar L_{B} may range from 18.0 mm to 210.0 mm, the diameter of the bar D_{B} may range from 10.0 mm to 20.0 mm, the length of the foot L_{E} may range from 10.0 mm to 20.0 mm, the diameter of the foot D_{E} may range from 27.2 mm to 54.3 mm and the length of the arm L_{A} may range from 9.0 mm to 30.0 mm. In particular embodiments, stabilizer 20 may have the following dimensions:

| | Length of | Diameter of | Length of | Diameter of | Length of | Compressed | Extended |
|---|---|---|---|---|---|---|---|
| | bar (L_{B}) | bar (D_{B}) | foot (L_{F}) | foot (D_{F}) | arm (L_{A}) | length (L_{C}) | length (L_{E}) |
| Example | (mm) | (mm) | (mm) | (mm) | (mm) | (mm) | (mm) |
| 1 | 18.0 | 10.0 | 10.0 | 27.2 | 9.0 | 38.0 | 54.0 |
| 2 | 26.0 | 10.0 | 14.0 | 38.0 | 13.0 | 54.0 | 78.0 |
| 3 | 34.0 | 11.0 | 18.0 | 48.9 | 17.0 | 70.0 | 101.1 |
| 4 | 60.0 | 20.0 | 20.0 | 54.3 | 30.0 | 100.0 | 150.0 |
| 5 | 110.0 | 20.0 | 20.0 | 54.3 | 30.0 | 150.0 | 200.0 |
| 6 | 160.0 | 20.0 | 20.0 | 54.3 | 30.0 | 200.0 | 250.0 |
| 7 | 210.0 | 20.0 | 20.0 | 54.3 | 30.0 | 250.0 | 300.0 |

In some embodiments, stabilizer 20 may comprise simple parts and materials. For example, feet 26, 26′ may be rubber truncated cones attached to steel threaded arms 32, 32′ which threadingly engage bar 22 which may be a steel cylinder with a single threaded axial bore 23 extending therethrough. In another example, feet 26, 26 may be rubber truncated cones attached to steel cylinders with threaded bores, which threadingly engage a bar 22 with threaded ends.

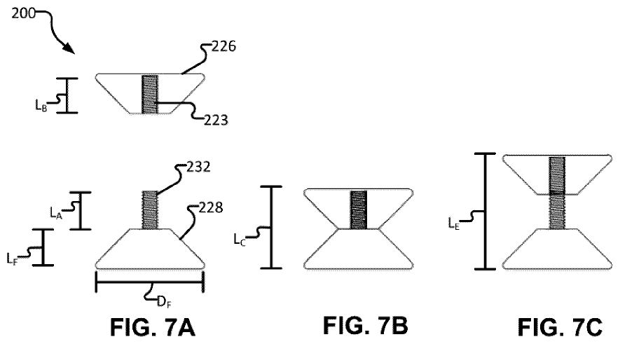

As will be apparent to those skilled in the art in light of the foregoing disclosure, many alterations and modifications are possible in the practice of this invention without departing from the spirit or scope thereof. Possible alterations and modifications include, without limitation:
Stabilizer 20 may be installed adjacent to a side of non-fixed structure 36 instead of adjacent to its top surface as shown in FIG. 3. For example, stabilizer 20 may contact a left outer surface of a mini-fridge, and a wall of a cabinet. In such embodiments, bar 22 (and longitudinal direction 24) may extend generally horizontally, and foot assemblies 25, 25′ (and transverse direction 30) may extend generally vertically, once stabilizer 20 is installed. In some embodiments, one or more stabilizers 20 are provided for each side surface of non-fixed structure 36. For example, FIG. 4B shows a stabilizer 20 provided on each side of a mini-fridge MF in a cabinet C.
In some embodiments, only one of the foot assemblies 25, 25′ is extendable in longitudinal direction 24, while the other foot remains fixed in longitudinal direction 24 relative to bar 22.
In some embodiments, the surfaces of non-fixed structure 36 and fixed structure 38 which define gap 34 may not be planar as shown in FIG. 3. For example, these surfaces may have some curvature or some irregular shape. In such embodiments, bearing surfaces 27, 27′ may be shaped to match the profile of the surfaces. In some embodiments, bearing surfaces 27, 27′ may be malleable, such that they are able to conform to the shape(s) of the surfaces.
In some embodiments, particularly when gap 34 is small, bar 22 may be absent. As shown in FIGS. 7A to 7C, stabilizer 200 has no bar, and instead one of the feet 226 has a bore 223 for directly receiving a threaded arm 232 of the other foot 228. In some embodiments, and having regard to FIGS. 7A to 7C, the length of the foot L_{E} may range from 10.0 mm to 18.0 mm, the diameter of the foot D_{E} may range from 27.2 mm to 48.9 mm and the length of the arm L_{A} may range from 9.0 mm to 17.0 mm, the compressed length (L_{C}) may range from 20.0 mm to 36.0 mm and the extended length (L_{E}) may range from 28.5 mm to 51.6 mm. In particular embodiments, bar less stabilizer 200 may have the following dimensions:

| | Length of | Diameter of | Length of | Compressed | Extended |
|---|---|---|---|---|---|
| Ex- | foot (L_{F}) | foot (D_{F}) | arm (L_{A}) | length (L_{C}) | length (L_{E}) |
| ample | (mm) | (mm) | (mm) | (mm) | (mm) |
| 1 | 10.0 | 27.2 | 9.0 | 20.0 | 28.5 |
| 2 | 14.0 | 38.0 | 13.0 | 28.0 | 39.3 |
| 3 | 18.0 | 48.9 | 17.0 | 36.0 | 51.6 |

### Interpretation of Terms

Unless the context clearly requires otherwise, throughout the description and the aspects:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “leading”, “trailing”, “proximal”, “distal”, “upwards”, “downwards”, “vertical”, “horizontal”, and the like, used in this description and any accompanying aspects (where present), depend on the specific orientation of the apparatus described and illustrated. The subject matter described herein may assume various alternative orientations. Accordingly, these directional terms are not strictly defined and should not be interpreted narrowly.

For example, while processes or blocks are presented in a given order, alternative examples may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times.

Where a component (e.g. an arm, a joint, a foot, a bar, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting or combining features, elements and/or acts from described embodiments.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

What is claimed is:

1. A method for stabilizing a mini-fridge against movement relative to a cabinet, the method comprising:
positioning a mini-fridge in a desired location in a cabinet;
providing a stabilizer, the stabilizer comprising a pair of foot assemblies, wherein at least one of the foot assemblies is extendable in a longitudinal direction in relation to the other one of the foot assemblies, each of the foot assemblies comprising a foot;
positioning the stabilizer into a gap defined by an exterior surface of the mini-fridge and an interior surface of the cabinet such that the longitudinal direction extends generally perpendicularly to the exterior surface of the mini-fridge and the interior surface of the cabinet; and
extending at least one of the feet of the stabilizer until one foot is in contact with the exterior surface of the mini-fridge and the other foot is in contact with the exterior surface of the cabinet, such that the stabilizer is snugly fit in the gap to prevent relative movement between the mini-fridge and the cabinet.

2. A method according to claim 1 wherein snugly fitting the stabilizer in the gap to prevent relative movement between the mini-fridge and the cabinet comprises extending the at least one feet of the stabilizer such that friction force between the feet of the stabilizer and the exterior surface of the mini-fridge and the interior surface of the cabinet is great enough to overcome a force provided by opening or closing a door of the mini-fridge.

3. A method according to claim 2 wherein the exterior surface of the mini-fridge is an upper exterior surface of the mini-fridge and the interior surface of the cabinet is an upper interior surface of the cabinet.

4. A method according to claim 2 wherein the exterior surface of the mini-fridge is a side exterior surface of the mini-fridge and the interior surface of the cabinet is a side interior surface of the cabinet.

5. A method according to claim 1 wherein the stabilizer comprises a bar that engages the foot assemblies at opposing ends thereof.

6. A method according to claim 5 wherein the bar comprises at least one axial bore for threaded engagement with a threaded arm of at least one of the foot assemblies.

7. A method according to claim 5 wherein the bar comprises threaded ends for threaded engagement with a threaded bore of an arm of at least one of the foot assemblies.

8. A method according to claim 1 wherein the one of the foot assemblies comprises a threaded bore and the other one of the foot assemblies comprises a threaded arm for threadingly engaging the threaded bore.

9. A method according to claim 1 wherein the feet comprise bearing surfaces made of a high friction material and/or featuring high friction features.

10. A method according to claim 1 wherein the gap ranges from 20 mm to 300 mm.

11. A method according to claim 1 wherein the feet comprise truncated cones made of rubber.

12. A system for securing a mini-fridge in a cabinet, the system comprising:
a mini-fridge;
a cabinet comprising an interior space sufficient to house the mini-fridge;
a stabilizer comprising a pair of foot assemblies, wherein at least one of the foot assemblies is extendable in a longitudinal direction in relation to the other one of the foot assemblies, each of the foot assemblies comprising a foot;
whereby the stabilizer is positionable in a gap defined by an exterior surface of the mini-fridge and the interior surface of the cabinet such that the longitudinal direction extends generally perpendicularly to the exterior surface of the mini-fridge and the interior surface of the cabinet; and
whereby the at least one of the feet is extendable until it is in contact with the exterior surface of the mini-fridge and the other foot is in contact with the exterior surface of the cabinet, such that the stabilizer is snugly fit in the gap to prevent relative movement between the mini-fridge and the cabinet.

13. A system according to claim 12 wherein the stabilizer is configured such that friction force between the feet of the stabilizer and the exterior surface of the mini-fridge and the interior surface of the cabinet is great enough to overcome a force provided by opening or closing a door of the mini-fridge.

14. A system according to claim 13 wherein the exterior surface of the mini-fridge is an upper exterior surface of the mini-fridge and the interior surface of the cabinet is an upper interior surface of the cabinet.

15. A system according to claim 13 wherein the exterior surface of the mini-fridge is a side exterior surface of the mini-fridge and the interior surface of the cabinet is a side interior surface of the cabinet.

16. A system according to claim 12 wherein the stabilizer comprises a bar that engages the foot assemblies at opposing ends thereof.

17. A system according to claim 16 wherein the bar comprises at least one axial bore for threaded engagement with a threaded arm of at least one of the foot assemblies.

18. A system according to claim 16 wherein the bar comprises threaded ends for threaded engagement with a threaded bore of an arm of at least one of the foot assemblies.

19. A system according to claim 12 wherein the one of the foot assemblies comprises a threaded bore and the other one of the foot assemblies comprises a threaded arm for threadingly engaging the threaded bore.

20. A system according to claim 12 wherein the feet comprise bearing surfaces made of a high friction material and/or featuring high friction features.

21. A system according to claim 12 wherein the feet comprise truncated cones made of rubber.
